(19) United States
(12) Patent Application Publication
(10) Pub. No.: US 2023/0152777 A1
(43) Pub. Date: May 18, 2023

(54) METHOD FOR DETECTING ABNORMALITY

(71) Applicant: MISOINFO Tech., Seoul (KR)

(72) Inventors: Dong Uk An, Seoul (KR); Su-young Ho, Seoul (KR); Sang-do Nam, Seoul (KR); Jin-ho Son, Hanam-si (KR); Kwang-jae Won, Suwon-si (KR); Dong Hyun Seo, Goyang-si (KR)

(21) Appl. No.: 17/984,156

(22) Filed: Nov. 9, 2022

(30) Foreign Application Priority Data
Nov. 12, 2021 (KR) 10-2021-0155795

(51) Int. Cl. G05B 19/406; G06N 3/045

(52) U.S. Cl. CPC G05B 19/406; G06N 3/045; G05B 2219/34465

(57) ABSTRACT

Disclosed is a method for detecting an abnormality performed by a computing device including one or more processors according to some aspects of the present disclosure. The method may include: acquiring first sensor data output from a first sensor among a plurality of sensors; selecting a first neural network model determined as an optimal network model from among a plurality of neural network models different from each other; generating first output data by inputting the first sensor data to the first neural network model; and determining whether an abnormality exists in the first sensor data based on the first sensor data and the first output data.

### CROSS REFERENCE TO RELATED APPLICATION

The present application claims priority to Korean Patent Application No. 10-2021-0155795, filed on Nov. 12, 2021, the entire contents of which is incorporated herein for all purposes by this reference.

### BACKGROUND

### 1. Field

One aspect of the present disclosure relates to a method for detecting an abnormality, and more specifically, to a method for detecting an abnormality using a neural network.

### 2. Description of Related Art

Generally, management of manufacturing facilities is important in manufacturing sites. In particular, since high process accuracy is required in a micro process, such as semiconductor manufacturing equipment, it is important to maintain a normal state.

Thus, in the manufacturing sites, it has been attempted to grasp the normal state based on measured data of equipment parts.

However, conventionally, since a person directly analyzes the measured data of the equipment parts in the manufacturing sites, it takes a certain period of time for the analysis. Therefore, conventionally, it is difficult to grasp the state of the manufacturing equipment in real time, and accuracy of the analysis is lowered.

Accordingly, there is a need to research and develop a method for detecting an abnormality in manufacturing equipment in real time.

### RELATED ART DOCUMENTS

### Patent Documents

(Patent Document 0001) Korean Unexamined Patent Publication No. 10-2012-0074630 (published on Jul. 6, 2012)

### SUMMARY

One aspect of the present disclosure has been devised in response to the above background art, and provides a method for detecting an abnormality.

The technical objects of the present disclosure are not limited to the technical objects mentioned above, and other technical objects not mentioned will be clearly understood by those skilled in the art from the following description.

In order to achieve the object as described above, some aspects of the present disclosure disclose a method for detecting an abnormality performed by a computing device including one or more processors may include: acquiring first sensor data output from a first sensor among a plurality of sensors; selecting a first neural network model determined as an optimal network model from among a plurality of neural network models different from each other; generating first output data by inputting the first sensor data to the first neural network model; and determining whether an abnormality exists in the first sensor data based on the first sensor data and the first output data.

Alternatively, the determining of whether the abnormality exists in the first sensor data based on the first sensor data and the first output data may include: calculating first comparison result data by comparing the first sensor data with the first output data; and determining whether an abnormality exists in the first sensor data based on a first variable included in the first comparison result data and a first threshold corresponding to the first variable.

Alternatively, the determining of whether the abnormality exists in the first sensor data based on the first variable included in the first comparison result data and the first threshold corresponding to the first variable may include recognizing that the abnormality exists in the first sensor data and generating a first abnormality detection signal, when the first variable exceeds the first threshold, and the first abnormality detection signal may include first information related to a cause of the abnormality recognized based on the first sensor data.

Alternatively, the selecting of the first neural network model determined as an optimal network model from among the plurality of neural network models different from each other may include: selecting a first feature value serving as a reference for determining whether an abnormality exists among feature values included in the first sensor data; acquiring an output of each of the plurality of neural network models by individually inputting the first feature value to the plurality of neural network models; and evaluating performances of each of the plurality of neural network models based on the acquired output, and selecting the first neural network model from among the plurality of neural network models based on scores of the evaluated performances.

Alternatively, the selecting of the first feature value as the reference for determining whether the abnormality exists among the feature values included in the first sensor data may include: selecting the first feature value using at least one of support vector machine recursive feature elimination (SVM-RFE), minimum redundancy maximum relevance (mRMR), principle component analysis (PCA), or multilinear principal component analysis (MPCA).

Alternatively, the method may further include: acquiring second sensor data output from a second sensor among the plurality of sensors; selecting a second neural network model determined as an optimal network model from among the plurality of neural network models different from each other; generating second output data by inputting the second sensor data to the second neural network model; generating first combination data by combining the first output data and the second output data; and determining whether an abnormality exists in the first combination data based on the first combination data and pre-stored normal data.

Alternatively, the determining of whether the abnormality exists in the first combination data based on the first combination data and the pre-stored normal data may include: calculating comprehensive comparison result data by comparing the first combination data with the pre-stored normal data; and determining whether an abnormality exists in the first combination data based on a second variable included in the comprehensive comparison result data and a second threshold corresponding to the second variable.

Alternatively, the determining of whether the abnormality exists in the first combination data based on the second variable included in the comprehensive comparison result data and the second threshold corresponding to the second variable may include recognizing that the abnormality exists in the first combination data and generating a second abnormality detection signal, when the second variable exceeds the second threshold, and the second abnormality detection signal may include second information related to a cause of the abnormality recognized based on the first combination data.

Alternatively, the selecting of the second neural network model determined as an optimal network model from among the plurality of neural network models different from each other may include: selecting a second feature value serving as a reference for determining whether an abnormality exists among feature values included in the second sensor data; acquiring an output of each of the plurality of neural network models by individually inputting the second feature value to the plurality of neural network models; and evaluating performances of each of the plurality of neural network models based on the acquired output, and selecting the second neural network model from among the plurality of neural network models based on scores of the evaluated performances.

Alternatively, the selecting of the second feature value as the reference for determining whether the abnormality exists among the feature values included in the first sensor data may include: selecting the first feature value using at least one of support vector machine recursive feature elimination (SVM-RFE), minimum redundancy maximum relevance (mRMR), principle component analysis (PCA), or multilinear principal component analysis (MPCA).

In order to achieve the object as described above, some aspects of the present disclosure disclose a computer program stored in a computer-readable storage medium including the computer program comprising instructions for allowing a processor of a computing device to perform the following steps in order to detect an abnormality, wherein the steps include: acquiring first sensor data output from a first sensor among a plurality of sensors; selecting a first neural network model determined as an optimal network model from among the plurality of neural network models different from each other; generating first output data by inputting the first sensor data to the first neural network model; and determining whether or not an abnormality exists in the first sensor data based on the first sensor data and the first output data.

In order to achieve the object as described above, some aspects of the present disclosure disclose a computing device for detecting an abnormality, the computing device including: a processor including at least one core; a memory configured to store a computer program that is executable by the processor; and a network unit, wherein the processor may acquire first sensor data output from a first sensor among a plurality of sensors, select a first neural network model determined as an optimal network model from among a plurality of neural network different from each other, generate first output data by inputting the first sensor data to the first neural network, and determine whether an abnormality exists in the first sensor data based on the first sensor data and the first output data.

The present disclosure can detect an abnormality using a neural network.

The effects obtainable in the present disclosure are not limited to the above-mentioned effects, and other effects not mentioned will be clearly understood by those skilled in the art to which the present disclosure belongs from the description below.

### BRIEF DESCRIPTION OF DRAWINGS

Various aspects are now described with reference to the drawings, wherein like reference numerals are used to refer to like elements collectively. In the following aspects, for the purpose of explanation, numerous specific details are set forth in order to provide a thorough understanding of one or more aspects. However, it will be appreciated that such aspect(s) may be practiced without the specific details.

FIG. 1 is a diagram illustrating a system for detecting an abnormality according to some aspects of the present disclosure.

FIG. 2 is a block diagram of a computing device for detecting an abnormality according to some aspects of the present disclosure.

FIG. 3 is a schematic diagram illustrating a neural network model according to some aspects of the present disclosure.

FIG. 4 is a flowchart for illustrating a process of detecting an abnormality through the computing device according to some aspects of the present disclosure.

FIG. 5 is a flowchart for illustrating a process for selecting a first neural network model through the computing device according to some aspects of the present disclosure.

FIG. 6 is a diagram for illustrating a process for detecting an abnormality through the computing device according to some aspects of the present disclosure.

FIG. 7 is a flowchart for illustrating a process for detecting an abnormality through a computing device according to some other aspects of the present disclosure.

FIG. 8 is a flowchart for illustrating a process for selecting a second neural network model through the computing device according to some other aspects of the present disclosure.

FIG. 9 is a diagram for illustrating a process for detecting an abnormality through the computing device according to some other aspects of the present disclosure.

FIG. 10 is a simplified general schematic diagram for an exemplary computing environment in which some aspects of the present disclosure may be implemented.

### DETAILED DESCRIPTION

Various aspects are now disclosed with reference to the drawings. In the following description, numerous specific details are set forth to provide a thorough understanding of the present disclosure. However, it will also be appreciated that such aspects may be practiced without these specific details.

The terms “component,” “module,” “system,” and the like, as used herein, refer to a computer-related entity, hardware, firmware, software, a combination of software and hardware, or execution of software. For example, a component can be, but is not limited thereto, a procedure executed in a processor, a processor, an entity, a thread of execution, a program, and/or a computer. For example, both an application executed in a computing device and the computing device may be a component. One or more components may reside within a processor and/or thread of execution. One component may be localized within one computer. One component may be distributed between two or more computers. In addition, these components can be executed from various computer-readable media having various data structures stored therein. For example, components may communicate via local and/or remote processes according to a signal having one or more data packets (for example, data from one component interacting with another component in a local system and a distributed system, and/or data transmitted via another system and a network such as an Internet through a signal).

In addition, the term “or” is intended to mean inclusive “or”, not exclusive “or”. In other words, unless otherwise specified or if unclear in context, the expression “X uses A or B” is intended to mean one of the natural inclusive substitutions. In other words, when X uses A; X uses B; or X uses both A and B, the expression “X uses A or B” can be applied to either of these cases. It is also to be understood that the term “and/or” used herein refers to and includes all possible combinations of one or more of the listed related items.

In addition, the terms “comprises” and/or “comprising” indicate the presence of corresponding features and/or elements. However, the terms “comprises” and/or “comprising” do not exclude the presence or addition of one or more other features, components, and/or groups thereof. Further, unless otherwise specified or unless it is clear from the context to refer to a singular form, the singular in the specification and claims may generally be construed to refer to “one or more”.

Further, the term “at least one of A or B” has to be interpreted to refer to “including only A”, “including only B”, and “a combination of configurations of A and B”.

Those skilled in the art will further appreciate that the various illustrative logical blocks, configurations, modules, circuits, devices, logics, and algorithm steps described in connection with the aspects disclosed herein may be implemented in electronic hardware, computer software, or combinations of both. To clearly illustrate this interchangeability of hardware and software, various illustrative components, blocks, configurations, devices, logics, modules, circuits, and steps have been described above generally in terms of their functionality. Whether such functionality is implemented as hardware or software depends upon the specific application and design restrictions imposed on the overall system. Those skilled in the art may implement the described functionality in various ways for each specific application. However, such implementation decisions may not be interpreted as a departure from the scope of the present disclosure.

The description of the presented aspects is provided to enable any person skilled in the art to make or use the present disclosure. Various modifications to these aspects will be readily apparent to those skilled in the art. The generic principles defined herein may be applied to other aspects without departing from the scope of the present disclosure. Thus, the present disclosure is not intended to be limited to the aspects presented herein. However, the present disclosure is to be construed in the widest scope consistent with the principles and novel features presented herein.

In the present disclosure, a network function and a neural network, a neural network model, and a neural network may be used interchangeably.

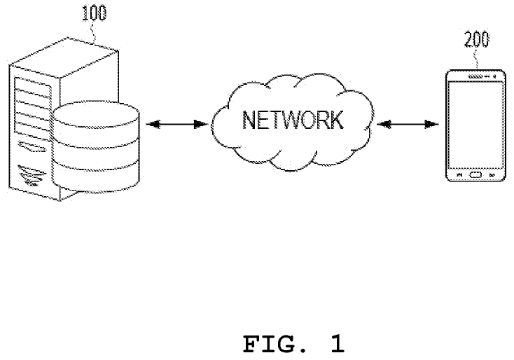

FIG. 1 is a diagram illustrating a system for detecting an abnormality according to some aspects of the present disclosure.

Referring to FIG. 1, a system for detecting an abnormality according to some aspects of the present disclosure may include a computing device 100, an external device 200, and a network. However, the above-described components are not essential for implementing the system, and the system may have more or fewer components than those listed above.

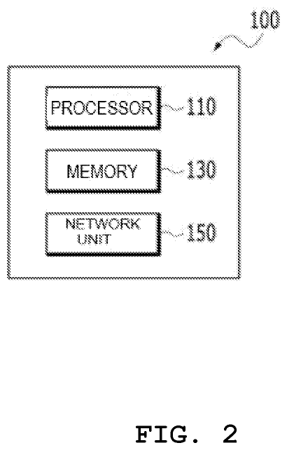

First, detailed descriptions of the computing device 100 will be described later with reference to FIG. 2.

FIG. 2 is a block diagram of a computing device for detecting an abnormality according to some aspects of the present disclosure.

The configuration of the computing device 100 shown in FIG. 2 is only a simplified example. In one aspect of the present disclosure, the computing device 100 may include other components for performing the computing environment of the computing device 100, and only some of the disclosed components may configure the computing device 100.

Referring to FIG. 2, the computing device 100 may include a processor 110, a memory 130, and a network unit 150.

The computing device 100 according to some aspects of the present disclosure may be a device for detecting an abnormality. The computing device 100 may be a device for determining whether an abnormality exists in sensor data using sensor data output from a plurality of sensors. For example, the computing device 100 may determine whether the abnormality exists in the sensor data using the sensor data output from the plurality of sensors attached to a device (for example, manufacturing equipment). In addition, when the abnormality exists in the sensor data, the computing device 100 may recognize the sensor that outputs the sensor data in which the abnormality exists, and recognize that there is a problem in the device to which the corresponding sensor is attached.

In general, the processor 110 may control the overall operation of the computing device 100. The processor 110 may process signals, data, information, etc. that are input or output through components of the computing device 100 or drive an application program stored in the memory 130, to provide or process information or functions appropriate to a user.

Further, the processor 110 may control at least one of the components of the computing device 100 in order to drive the application programs stored in the memory 130. Moreover, the processor 110 may be operated by combining at least two components included in the computing device 100 in order to drive the application program.

The processor 110 may consist of one or more cores, and may include a processor for data analysis and deep learning of a central processing unit (CPU) of a computing device, a general purpose graphics processing unit (GPGPU), a tensor processing unit (TPU), and the like. The processor 110 may read a computer program stored in the memory 130 and perform data processing for machine learning according to one aspect of the present disclosure. According to one aspect of the present disclosure, the processor 110 may perform an operation for learning the neural network. The processor 110 may perform the calculation for learning the neural network, such as processing input data for learning in deep learning (DL), extracting features from input data, calculating an error, and updating the weight of the neural network using backpropagation. At least one of a CPU, a GPGPU, and a TPU of the processor 110 may process the learning of a network function. For example, the CPU and the GPGPU together can process the learning of a network function and data classification using the network function. Further, in one aspect of the present disclosure, learning of a network function and data classification using the network function may be processed by using the processors of a plurality of computing devices together. In addition, the computer program executed in the computing device according to one aspect of the present disclosure may be a CPU, GPGPU or TPU executable program.

The memory 130 may store any type of information created or determined by the processor 110 and any type of information received by the network unit 150. For example, the memory 130 may store an abnormality detection signal generated by the processor 110.

The memory 130 may include at least one type of storage media including a flash type memory, a hard disk type memory, a multimedia card micro type memory, a card type memory (for example, SD or XD memory, etc.), a random access memory (RAM). a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in relation to a web storage that performs a storage function of the memory 130 on the Internet. The description of the above memory is only an example, and the present disclosure is not limited thereto.

The network unit 150 may include any wired/wireless communication network capable of transmitting and receiving any type of data and signals in the network represented in the present disclosure. The techniques described herein may be used in other networks as well as in the networks mentioned above.

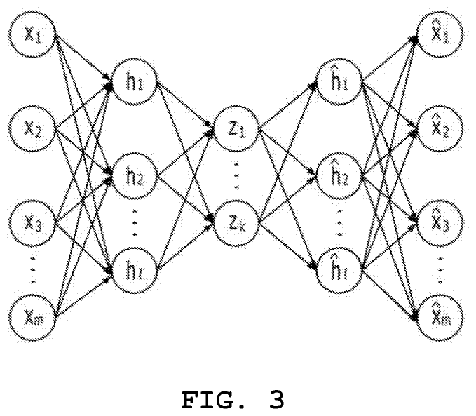

Meanwhile, the processor 110 may input the sensor data output from the plurality of sensors to the neural network model 300 to output data. The neural network model 300 will be described later with reference to FIG. 3.

FIG. 3 is a schematic diagram illustrating a neural network model 300 according to one aspect of the present disclosure.

Throughout the specification, a calculation model, a neural network, a neural network model, a network function, and a neural network may be used interchangeably. The neural network may be composed of a set of interconnected calculation units, which may generally be referred to as nodes. These nodes may also be referred to as neurons. The neural network is configured to include at least one or more nodes. Nodes (or neurons) constituting the neural network may be interconnected by one or more links.

In the neural network, one or more nodes connected through a link may relatively form a relationship between an input node and an output node. The concept of the input node and the output node is relative, and any node serving as an output node with respect to one node may serve as an input node with respect to another node, and vice versa. As described above, an input node-to-output node relationship may be created about a link. One or more output nodes may be connected to one input node through a link, and vice versa.

In the relationship between the input node and the output node connected to each other through one link, the value of the data of the output node may be determined based on data input to the input node. A link that interconnects the input node and the output node may have a weight. The weight may be variable, and may be changed by the user or algorithm in order to allow the neural network to perform a desired function. For example, when one or more input nodes are interconnected to one output node by respective links, the output node may determine the output node value based on the values input to the input nodes connected to the output node and the weight assigned to the links corresponding to the respective input nodes.

As described above, one or more nodes are interconnected through one or more links in the neural network, thereby forming the relationship between the input node and an output node in the neural network. The characteristics of the neural network may be determined according to the number of nodes and links in the neural network, the correlation between the nodes and the links, and the value of a weight assigned to each of the links. For example, when there are two neural networks including the same number of nodes and links and having different weight values of the links, the two neural networks may be recognized as they are different from each other.

The neural network may consist of a set of one or more nodes. A subset of nodes constituting the neural network may constitute a layer. Some of the nodes constituting the neural network may configure one layer based on distances from the initial input node. For example, a set of nodes having a distance n from the initial input node may constitute n layers. The distance from the initial input node may be defined by the minimum number of links required to pass therethrough to reach the corresponding node from the initial input node. However, the definition of such a layer is arbitrary for description, and the order of the layer in the neural network may be defined in a different way from the above. For example, a layer of nodes may be defined by a distance from the final output node.

The initial input node may refer to one or more nodes to which data is directly input without going through a link in a relationship with other nodes among nodes in the neural network. Alternatively, in a relationship between nodes based on a link in a neural network, it may mean nodes that do not have other input nodes connected by a link. Similarly, the final output node may refer to one or more nodes that do not have an output node in a relationship with other nodes among nodes in the neural network. In addition, a hidden node may mean nodes constituting the neural network other than the first input node and the final output node.

The neural network according to one aspect of the present disclosure may be a neural network in which the number of nodes in the input layer may be the same as the number of nodes in the output layer, and the number of nodes decreases and then increases again from the input layer to the hidden layer. In addition, the neural network according to another aspect of the present disclosure may be a neural network in which the number of nodes in the input layer may be less than the number of nodes in the output layer, and the number of nodes decreases from the input layer to the hidden layer. In addition, the neural network according to another aspect of the present disclosure may be a neural network in which the number of nodes in the input layer may be greater than the number of nodes in the output layer, and the number of nodes increases from the input layer to the hidden layer. The neural network according to another aspect of the present disclosure may be a neural network which is a combination of the aforementioned neural networks.

A deep neural network (DNN) may refer to a neural network including a plurality of hidden layers in addition to an input layer and an output layer. The deep neural network can be used to identify the latent structures of data. In other words, it can identify the potential structure of photos, texts, videos, voices, and music (e.g., what objects are in the photos, what the text and emotions are, what the texts and emotions are, etc.). The deep neural network may include convolutional neural networks (CNNs), recurrent neural networks (RNNs), autoencoders, generative adversarial networks (GANs), and restricted Boltzmann machines (RBMs), deep belief networks (DBNs), Q networks, U networks, Siamese networks, and generative adversarial networks (GANs). The above description of the deep neural network is only an example, and the present disclosure is not limited thereto.

In one aspect of the present disclosure, the network function may include an autoencoder. The autoencoder may be a kind of artificial neural network for outputting output data similar to input data. The autoencoder may include at least one hidden layer, and an odd number of hidden layers may be disposed between the input/output layers. The number of nodes in each layer may be reduced from the number of nodes of the input layer to the number of nodes of an intermediate layer called a bottleneck layer (encoding), and then expanded from the bottleneck layer to the output layer (symmetrical with the input layer) symmetrically with the reduction. The autoencoder can perform non-linear dimensionality reduction. The number of input layers and output layers may correspond to a dimension after preprocessing the input data. In the autoencoder structure, the number of nodes of the hidden layer included in the encoder may decrease as it moves away from the input layer. If the number of nodes in the bottleneck layer (the layer with the fewest nodes located between the encoder and decoder) is too small, a sufficient amount of information may not be delivered, so the number of nodes is maintained at a certain number or more (e.g., half or more of the input layer, etc.).

The neural network may be trained using at least one of supervised learning, unsupervised learning, semi-supervised learning, and reinforcement learning. The training of the neural network may be a process for applying knowledge, which allows the neural network to perform a specific operation, to the neural network.

The neural network may be trained in a way that minimizes output errors. The training for the neural network refers to the process for iteratively inputting the learning data into the neural network, calculating the output of the neural network and the target error for the learning data, and updating the weight of each node of the neural network by backpropagating the error of the neural network from the output layer of the neural network to the input layer in the direction to reduce the error. In the case of supervised learning, learning data in which the correct answer is labeled in each learning data is used (that is, labeled learning data), and in the case of unsupervised learning, the correct answer may not be labeled in each learning data. That is, for example, learning data in the case of supervised learning regarding data classification may be data in which categories are labeled for each of the learning data. Labeled learning data is input to the neural network, and an error can be calculated by comparing the output (category) of the neural network with the label of the learning data. As another example, in the case of unsupervised learning regarding data classification, an error may be calculated by comparing the input learning data with the neural network output. The calculated error is backpropagated in the reverse direction (that is, from the output layer to the input layer) in the neural network, and the connection weight of each node of each layer in the neural network may be updated according to the backpropagation. A change amount of the connection weight of each node to be updated may be determined according to a learning rate. The calculation of the neural network on the input data and the backpropagation of errors may constitute a learning cycle (epoch). The learning rate may be applied differently depending on the number of repetitions of the learning cycle of the neural network. For example, in the early stage of learning of a neural network, a high learning rate can be used to enable the neural network to quickly acquire a certain level of performance, thereby increasing efficiency, and a low learning rate can be used at the end of learning to increase the accuracy.

In the learning of the neural network, in general, the learning data may be a subset of real data (that is, data to be processed using the learned neural network), and thus there is a learning cycle in which the error on the learning data is reduced, but the error on the real data is increased. Overfitting refers to a phenomenon in which errors on actual data increase by over-learning on learning data as described above. An example of the overfitting is a phenomenon in which a neural network that has learned a cat by seeing a yellow cat does not recognize a cat when it sees a cat having a color other than yellow. The overfitting may act as a cause of increasing errors in machine learning algorithms. In order to prevent such overfitting, various optimization methods can be used. In order to prevent the overfitting, methods such as increasing the learning data, regularization, dropout for deactivating some of the nodes of the network in the process of learning, and the use of a batch normalization layer can be applied.

According to one aspect of the present disclosure, a computer-readable medium that stores a data structure is disclosed.

The data structure may refer to organization, management, and storage of data that enables efficient access and modification of the data. The data structure may refer to an organization of data for solving specific problems (for example, data search, data storage, and data modification in the shortest time). The data structure may be defined as a physical or logical relationship between data elements designed to support a specific data processing function. The logical relationship between data elements may include a connection relationship between user-defined data elements. The physical relationship between data elements may include an actual relationship between data elements that are physically stored in a computer-readable storage medium (for example, a persistent storage device). The data structure may specifically include a set of data, relationships between data, and functions or instructions applicable to data. Through the effectively designed data structure, the computing device may perform an operation while using resources of the computing device to a minimum. Specifically, the computing device may increase efficiency of operation, read, insertion, deletion, comparison, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a manner that each data is connected in a row with a pointer. In the connection list, the pointer may include connection information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data arrangement structure that may access data limitedly and unlike a stack, the queue may be a data structure (FIFO-First in First Out) in which late stored data is output late. The deque may be a data structure capable of processing data at both ends of the data structure.

The nonlinear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

Throughout the specification, a calculation model, a neural network, a neural network model, a network function, and a neural network may be used interchangeably. Hereinafter, the computation model, the neural network, a network function, and the neural network are collectively described as a neural network. The data structure may include the neural network. In addition, the data structure including the neural network may be stored in a computer-readable medium. The data structure including the neural network may also include data pre-processed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. That is, the data structure including the neural network may include all of data pre-processed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer-readable medium may include a computer-readable recording medium and/or a computer-readable transmission medium. The neural network may be composed of a set of interconnected calculation units, which may generally be referred to as nodes. These nodes may also be referred to as neurons. The neural network is configured to include at least one or more nodes.

The data structure may include data input to the neural network. The data structure including the data input to the neural network may be stored in a computer-readable medium. The data input to the neural network may include training data input in a neural network training process and/or input data input to a neural network in which training has been completed. The data input to the neural network may include pre-processed data and/or data to be pre-processed. The preprocessing may include a data processing process for inputting data into the neural network. Therefore, the data structure may include data to be pre-processed and data generated by pre-processing. The data structure is only an example and the present disclosure is not limited thereto.

The data structure may include weights of the neural network (weights and parameters may be used as the same meaning in the present disclosure). In addition, the data structures including the weight of the neural network may be stored in the computer-readable medium. The neural network may include a plurality of weights. The weight may be variable, and may be changed by the user or algorithm in order to allow the neural network to perform a desired function. For example, when one or more input nodes are mutually connected to one output node by the respective links, the output node may determine an output node value based on values input in the input nodes connected with the output node and the parameters set in the links corresponding to the respective input nodes. The data structure is only an example and the present disclosure is not limited thereto.

By way of an example, but not limited thereto, the weight may include a weight which varies in the neural network training process and/or a weight in which neural network training has been completed. The weight which varies in the neural network training process may include a weight at a time when a training cycle starts and/or a weight that varies during the training cycle. The weight in which the neural network training has been completed may include a weight in which the training cycle is completed. Accordingly, the data structure including the weight of the neural network may include a data structure including the weight which varies in the neural network training process and/or the weight in which neural network training has been completed. Therefore, it is assumed that the above-described weights and/or combinations of respective weights are included in the data structure including the weights of the neural network. The data structure is only an example and the present disclosure is not limited thereto.

The data structure including the weight of the neural network may be stored in the computer-readable storage medium (e.g., memory, hard disk) after a serialization process. Serialization may be a process for storing data structures on the same or different computing devices and later reconfiguring the data structure and converting the data structure to a form that may be used. The computing device may serialize the data structure to transmit and receive data over the network. The data structure including the weight of the serialized neural network may be reconstructed in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures including the hyper-parameters of the neural network may be stored in the computer-readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (for example, the number of hidden layers and the number of nodes in the hidden layer). Therefore, the processor 110 of the computing device 100 may improve a performance of the neural network model 300 by adjusting hyper parameters of the neural network model 300. The data structure is only an example and the present disclosure is not limited thereto.

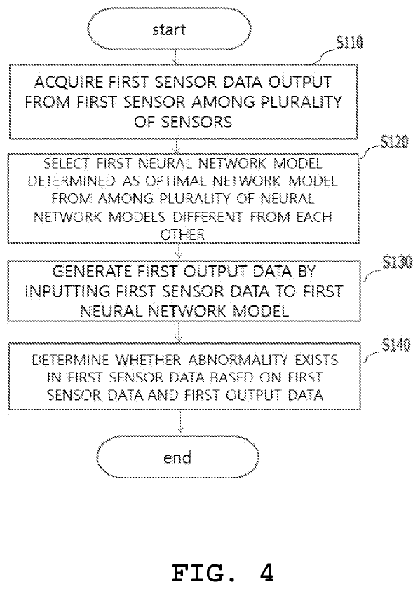

A method for detecting an abnormality using the neural network model 300 in the computing device 100 described with reference to FIGS. 1 to 3 will be described later with reference to FIG. 4.

FIG. 4 is a flowchart for illustrating a process for detecting an abnormality through the computing device according to some aspects of the present disclosure.

Referring to FIG. 4, the processor 110 of the computing device 100 may acquire a first sensor data output from a first sensor among a plurality of sensors (S110).

The plurality of sensors may be sensors for measuring a quality, performance, or failure of a device in order to perform factory automation, etc. For example, the plurality of sensors may include any sensor such as a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor, a microphone, a battery gauge, an environmental sensor (for example, a barometer, a hygrometer, a thermometer, a radiation sensor, a thermal sensor, gas sensors, etc.), and a chemical sensor (for example, an electronic nose, a health care sensor, a biometric sensor, etc.).

The sensor data (for example, the first sensor data) may include data or values acquired from the above-described plurality of sensors. The sensor data may include various types of data and values according to the type of sensor and the type of device measured by the sensor.

According to some aspects of the present disclosure, when the processor 110 acquires the sensor data of each sensor, the sensor data may be acquired by searching for information related to the device to which each sensor is attached. Therefore, when an abnormality exists in the sensor data of a specific sensor, the processor 110 may generate the information related to the device to which the specific sensor is attached, and control the network unit 150 to transmit the information related to the device to the external device 200. A user of the external device 200 may recognize a device with a problem through the information related to the device transmitted to the external device 200 and cope with the problem.

The processor 110 of the computing device 100 may select a first neural network model determined as an optimal network model from among a plurality of neural network models different from each other (S120).

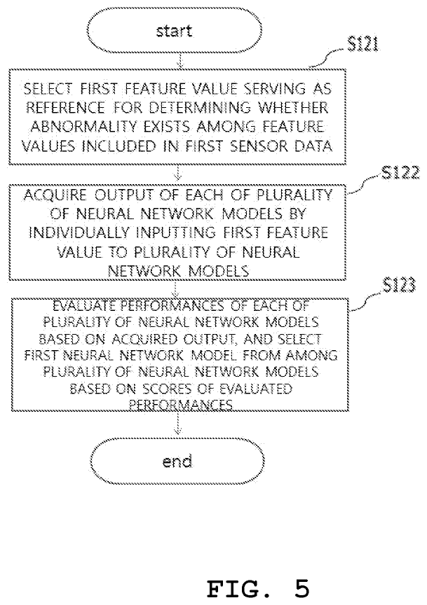

The detailed method for selecting a first neural network model will be described later with reference to FIG. 5.

FIG. 5 is a flowchart for illustrating a process of selecting a first neural network model through the computing device according to some aspects of the present disclosure.

Referring to FIG. 5, the processor 110 of the computing device 100 may select a first feature value serving as a reference for determining whether an abnormality exists among feature values included in the first sensor data (S121).

For example, the processor 110 of the computing device 100 may select the first feature value using at least one of support vector machine recursive feature elimination (SVM-RFE), minimum redundancy maximum relevance (mRMR), principle component analysis (PCA), or multilinear principal component analysis (MPCA).

The SVM-RFE may be a method for selecting a feature value based on a predetermined weight from among the feature values. For example, the SVM-RFE may be a method for optimizing the weight, setting a rank based on weights for feature values, and removing the feature value with the lowest rank from the selection. In addition, the SVM-RFE may be a method for selecting one finally remaining feature value by repeating the above-described process.

The mRMR may be a method for selecting a feature value based on correlation with dependent variables and redundancy with independent variables from among the feature values. For example, the mRMR may be a method for selecting a feature value having high correlation with the dependent variables and low redundancy with independent variables from among the feature values.

The principal component analysis may be a method for selecting a feature value serving as a principal component from among the feature values. For example, the principal component analysis may be a method for transforming feature values into a one-dimensional vector, distributing the feature values on coordinates, and selecting a feature value having a direction vector having the largest variance from among the distributed feature values.

A polylinear principal component analysis, which is polylinear extension of the principal component analysis, may be a method for selecting a feature value serving as a principal component from among the feature values. For example, the polylinear principal component may be a method for selecting a feature value using an eigenvector without transforming the feature values.

The processor 110 of the computing device 100 may acquire an output of each of the plurality of neural network models by individually inputting the first feature value to the plurality of neural network models (S122).

The processor 110 of the computing device 100 may evaluate performances of each of the plurality of neural network models based on the output acquired in step S122, and select a first neural network model from among the plurality of neural network models based on scores of the evaluated performances (S123).

For example, each of the plurality of neural network models may be a neural network model that is pre-trained using the feature value (for example, the first feature value) included in the sensor data (for example, the first sensor data) as training data. The plurality of neural network models may be the same models or models having different training methods and/or network structures according to implementation.

Referring back to FIG. 4, the processor 110 of the computing device 100 may generate a first output data by inputting the first sensor data to the first neural network model (S130).

The processor 110 of the computing device 100 may determine whether an abnormality exists in the first sensor data based on the first sensor data and the first output data (S140).

For example, the processor 110 of the computing device 100 may calculate first comparison result data by comparing the first sensor data with the first output data. Specifically, the processor 110 may generate first comparison sum data by summing the first sensor data and the first output data. The first comparison sum data may be residual data in which the first sensor data is compared with the first output data and only the different part thereof remains. In addition, the processor 110 may calculate the first comparison result data by removing noise from the first comparison sum data. Therefore, the first comparison result data may include a plurality of variables from which the noise is removed.

Further, the processor 110 may determine whether the abnormality exists in the first sensor data, based on the first variable among a plurality of variables included in the first comparison result data and the first threshold corresponding to the first variable. The plurality of variables, which are values estimated from detailed data included in the sensor data and the output data, may be values indicating specific properties. For example, the plurality of variables may include a variable for an image acquired through an image sensor, variable for an acceleration acquired through an acceleration sensor, etc.

Thresholds corresponding to each of the plurality of variables may be statistically predetermined through repeated experiments and stored in the memory 130. However, the method for determining thresholds is not limited to the above-described method, and the thresholds may be determined through various methods. The processor 110 may determine whether the abnormality exists in the first sensor data by comparing the first variable with the first threshold corresponding to the first variable pre-stored in the memory 130.

For example, when the first variable exceeds the first threshold, the processor 110 may recognize that the abnormality exists in the first sensor data and generate a first abnormality detection signal. Further, the processor 110 may transmit the first abnormality detection signal to the external device 200. The first abnormality detection signal may include first information related to a cause of the abnormality recognized based on the first sensor data. The first information related to the cause of the abnormality may include a time to acquire the first sensor data, information related to a device to which the first sensor is attached, etc.

For another example, when the first variable does not exceed the first threshold, the processor 110 may recognize that the first sensor data is normal and generate a first normal signal. Further, the processor 110 may transmit the first normal signal indicating that a current state is normal to the external device 200. The processor 110 may transmit the first normal signal to the external device 200 every preset time (for example, one minute).

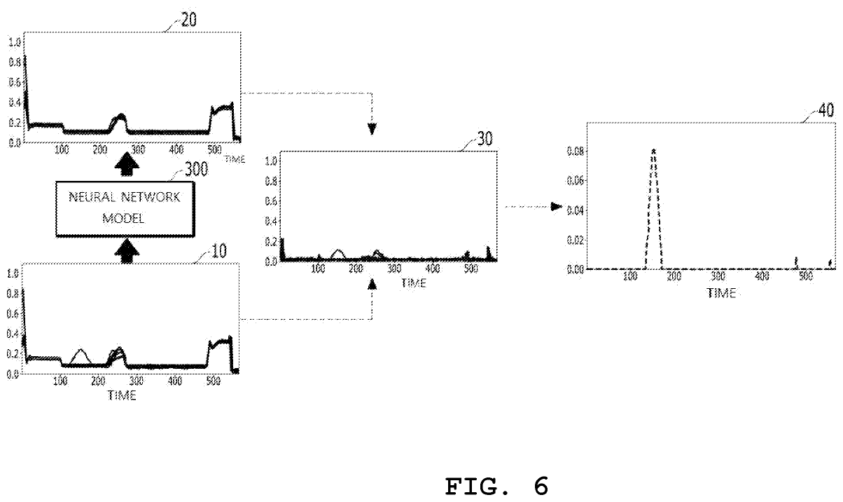

One aspect of a process for detecting an abnormality using the neural network model 300 in the computing device 100 described with reference to FIGS. 4 and 5 will be described later with reference to FIG. 6.

FIG. 6 is a diagram for illustrating a process for detecting an abnormality through the computing device according to some aspects of the present disclosure.

Referring to FIG. 6, the processor 110 of the computing device 100 may acquire sensor data 10 represented as a graph output from a specific sensor among the plurality of sensors. For example, the plurality of sensors may be sensors that measure a semiconductor manufacturing device. However, the plurality of sensors are not limited thereto, and may measure various devices.

Next, the processor 110 of the computing device 100 may generate output data 20 represented as a graph by inputting the data to the neural network model 300. As described above with reference to FIGS. 4 and 5, the neural network model 300 may be a specific neural network model determined as an optimal network model among the plurality of neural network models different from each other. For example, the neural network model 300 may be a denoising autoencoder (DAE). When data including the noise is input, the denoising autoencoder may be a neural network in which an autoencoder is partially modified to output data from which the noise is removed.

Next, the processor 110 of the computing device 100 may generate comparison sum data 30 represented as a graph by summing the sensor data 10 and the output data 20. The comparison sum data 30 may be data in which only different parts remain on the graph by comparing the sensor data 10 with the output data 20.

Next, the processor 110 of the computing device 100 may remove the noise from the comparison sum data 30 to calculate comparison result data 40 represented as a graph in which the plurality of variables exist. For example, the comparison result data 40 may be data obtained by removing wafer-to-wafer (W2W) variation and noise of the sensor from the sensor data 10 that is acquired from the sensor attached to the semiconductor manufacturing device.

Next, the processor 110 of the computing device 100 may determine whether the abnormality exists in the sensor data 10, based on the first variable among the plurality of variables included in the comparison result data 40 and the first threshold corresponding to the first variable. The processor 110 may select a variable having the highest peak value among the plurality of variables included in the comparison result data 40 as a first variable. The processor 110 may randomly select the first variable among the plurality of variables included in the comparison result data 40. However, the method for selecting a first variable among the plurality of variables is not limited thereto, and the first variable may be selected through various methods.

As described above with reference to FIGS. 4 to 6, the processor 110 of the computing device 100 may use the first neural model determined as an optimal network model among the plurality of neural network models, the performance is thus improved, thereby improving accuracy of determining whether the abnormality exists.

Further, the processor 110 of the computing device 100 may determine whether the abnormality exists in the sensor data by acquiring the sensor data from the plurality of sensors in real time, thereby recognizing a state of the device to which the sensor is attached in real time.

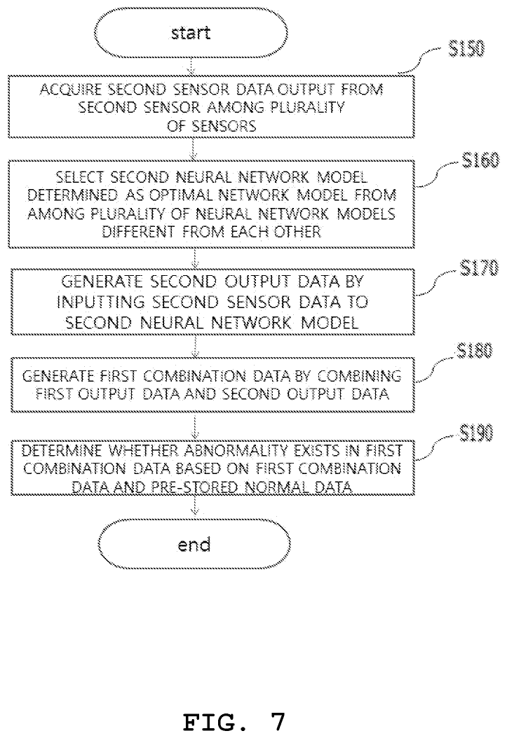

Meanwhile, a method for determining whether abnormal data exists using not only one sensor data but also a plurality of sensor data in the processor 110 of the computing device 100 will be described later with reference to FIGS. 7 to 9. A portion overlapping with contents of the computing device 100 described above with reference to FIGS. 4 to 6 may be omitted.

FIG. 7 is a flowchart for illustrating a process for detecting an abnormality through a computing device according to some other aspects of the present disclosure.

Referring to FIG. 7, the processor 110 of the computing device 100 may acquire a second sensor data output from a second sensor among a plurality of sensors (S150).

The processor 110 of the computing device 100 may select a second neural network model determined as an optimal network model from among the plurality of neural network models different from each other (S160).

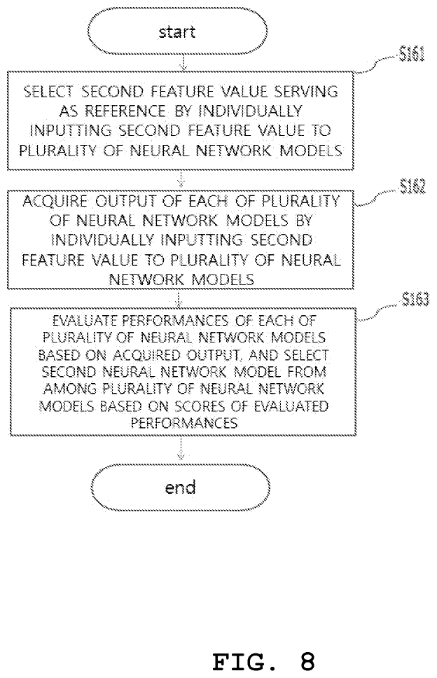

The detailed method for selecting a second neural network model will be described later with reference to FIG. 8.

FIG. 8 is a flowchart for illustrating a process for selecting a second neural network model through the computing device according to some other aspects of the present disclosure.

Referring to FIG. 8, the processor 110 of the computing device 100 may select a second feature value serving as a reference for determining whether an abnormality exists among feature values included in the second sensor data (S161).

For example, the processor 110 of the computing device 100 may select the second feature value using at least one of support vector machine recursive feature elimination (SVM-RFE), minimum redundancy maximum relevance (mRMR), principle component analysis (PCA), or multilinear principal component analysis (MPCA).

The processor 110 of the computing device 100 may acquire an output of each of the plurality of neural network models by individually inputting the second feature value to the plurality of neural network models (S162).

The processor 110 of the computing device 100 may evaluate performances of each of the plurality of neural network models based on the output acquired in step S162, and select a second neural network model from among the plurality of neural network models based on scores of the evaluated performances (S163).

For example, each of the plurality of neural network models may be a neural network model that is pre-trained using the feature value (for example, the second feature value) included in the sensor data (for example, the second sensor data) as training data. The plurality of neural network models may be the same models or models having different training methods and/or network structures according to implementation.

Referring back to FIG. 7, the processor 110 of the computing device 100 may generate a second output data by inputting the second sensor data to the second neural network model (S170).

The processor 110 of the computing device 100 may generate first combination data by combining the first output data and the second output data (S180).

Specifically, the processor 110 of the computing device 100 may calculate first comparison result data by comparing the first sensor data with the first output data. In addition, the processor 110 may calculate second comparison result data by comparing the second sensor data with the second output data. In addition, the processor 110 may generate first combination data by combining the first output data and the second output data.

The processor 110 of the computing device 100 may determine whether an abnormality exists in the first combination data based on the first combination data and normal data pre-stored in the memory 130 (S190).

For example, the processor 110 of the computing device 100 may calculate comprehensive comparison result data by comparing the first combination data with the pre-stored normal data. Further, the processor 110 may determine whether the abnormality exists in the first combination data, based on the second variable included in the comprehensive comparison result data and the second threshold corresponding to the second variable. The plurality of variables may be values estimated from detailed data included in the sensor data and the output data. Thresholds corresponding to each of the plurality of variables may be statistically predetermined through repeated experiments and stored in the memory 130. However, the method for determining thresholds is not limited to the above-described method, and the thresholds may be determined through various methods.

The processor 110 may determine whether the abnormality exists in the first combination data by comparing the second variable included in the comprehensive comparison result data with the second threshold corresponding to the second variable pre-stored in the memory 130.

For example, when the second variable exceeds the second threshold, the processor 110 may recognize that the abnormality exists in the first combination data and generate a second abnormality detection signal. Further, the processor 110 may transmit the second abnormality detection signal to the external device 200. The second abnormality detection signal may include second information related to a cause of the abnormality recognized based on the first combination data. The second information related to the cause of the abnormality may include a time to acquire the corresponding sensor data including the second variable, information related to a device to which the corresponding sensor is attached, etc. The processor 110 may recognize the sensor that outputs the abnormal sensor data by confirming whether the second variable is included in the comparison result data of which sensor. For example, when the second variable is included in the first comparison result data of the first sensor, the processor 110 may transmit, to the external device 200, the second abnormality detection signal including a time to acquire the first sensor data, information related to the device to which the first sensor is attached, etc.

For another example, when the second variable does not exceed the second threshold, the processor 110 may recognize that the first combination data is normal and generate a second normal signal. Further, the processor 110 may transmit the second normal signal to the external device 200. The processor 110 may transmit the second normal signal to the external device 200 every preset time (for example, one minute).

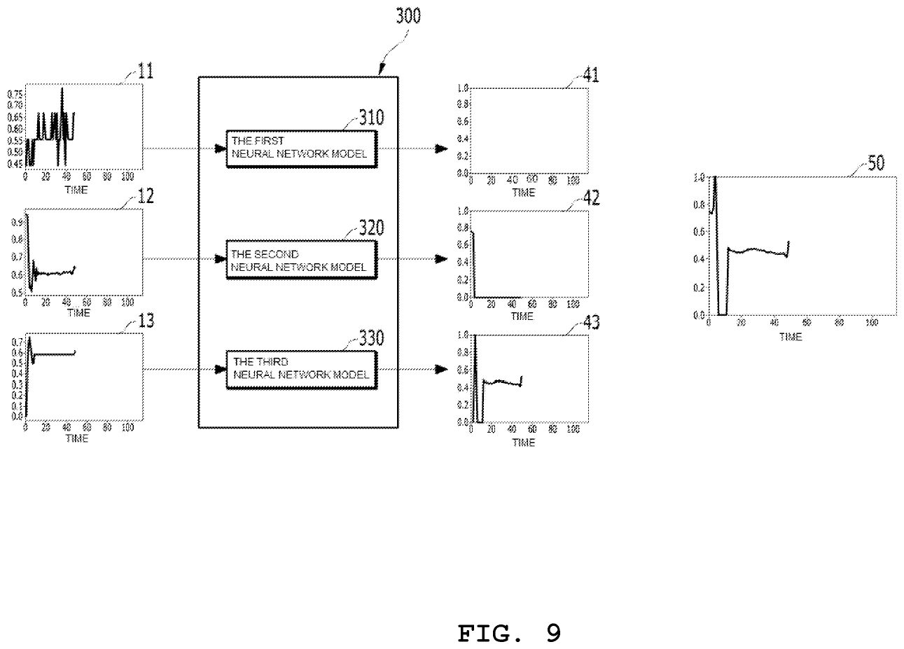

One aspect of a process for detecting an abnormality using the neural network model 300 in the computing device 100 described with reference to FIGS. 7 and 8 will be described later with reference to FIG. 9.

FIG. 9 is a diagram for illustrating a process for detecting an abnormality through the computing device according to some other aspects of the present disclosure.

Referring to FIG. 9, the processor 110 of the computing device 100 may acquire first sensor data 11, second sensor data 12, and third sensor data 13 represented as graphs output from each of the first sensor, the second sensor, and the third sensor from among the plurality of sensors.

Next, the processor 110 of the computing device 100 may acquire each comparison result data by inputting each sensor data to a neural network model determined as an optimal network model for each sensor data among the neural network models.

For example, the processor 110 may determine that the first neural network model 310 is optimal for the first sensor data 11, and calculate first comparison result data 41 by inputting the first sensor data 11 to the first neural network model 310. For example, the processor 110 may determine that the second neural network model 320 is optimal for the second sensor data 12, and calculate second comparison result data 42 by inputting the second sensor data 12 to the second neural network model 320. The processor 110 may determine that the third neural network model 330 is optimal for the third sensor data 13, and calculate third comparison result data 43 by inputting the third sensor data 13 to the third neural network model 330. In this case, the detailed process in which the processor 110 calculates the comparison result data by inputting the sensor data to the neural network model may be replaced with the contents described above with reference to FIG. 6.

For another example, the processor 110 may determine that the first neural network model 310 is optimal for the first sensor data 11, and calculate first comparison result data 41 by inputting the first sensor data 11 to the first neural network model 310. The processor 110 may determine that the first neural network model 310 is optimal for the second sensor data 12, and calculate second comparison result data 42 by inputting the second sensor data 12 to the first neural network model 310. The processor 110 may determine that the first neural network model 310 is optimal for the third sensor data 13, and calculate third comparison result data 43 by inputting the third sensor data 13 to the first neural network model 310. That is, the processor 110 may calculate the comparison result data for each of the plurality of sensors using only one neural network model.

Next, the processor 110 of the computing device 100 may generate first combination data 50 by combining the first comparison result data 41, the second comparison result data 42, and the third comparison result data 43.

Next, the processor 110 of the computing device 100 may calculate comprehensive comparison result data by comparing the first combination data with the pre-stored normal data.

Next, the processor 110 of the computing device 100 may determine whether the abnormality exists in the first combination data, based on the second variable included in the comprehensive comparison result data and the second threshold corresponding to the second variable. The processor 110 may select a variable having the highest peak value among the plurality of variables included in the comprehensive comparison result data as a second variable. The processor 110 may randomly select the second variable among the plurality of variables included in the comprehensive comparison result data. However, the method for selecting a second variable among the plurality of variables is not limited thereto, and the second variable may be selected through various methods.

As described above with reference to FIGS. 7 to 9, the processor 110 of the computing device 100 may determine the abnormality using combination data obtained by combining the sensor data acquired from the plurality of sensors, thereby reducing a time to determine the abnormality by collectively managing the plurality of sensors.

Referring back to FIG. 1, the external device 200 may refer to any type of nodes in a system having a mechanism for communication with the computing device 100. For example, the external device 200 may be a user terminal including a mobile terminal, a smartphone, etc. The external device 200 may receive abnormality detection signals (for example, the first abnormality detection signal and the second abnormality detection signal) from the computing device 100.

The network may include any wired/wireless communication network capable of transmitting and receiving any type of data and signals. Specifically, the network may include a wired/wireless communication network capable of transmitting and receiving abnormality detection signals between the computing device 100 and the external device 200.

As described above with reference to FIGS. 1 to 9, the computing device 100 according to some aspects of the present disclosure may acquire the sensor data from sensors attached to the device and determine the abnormality to transmit a signal to the external device 200. Therefore, a user of the external device 200 may grasp and cope with whether the device is normal in real time based on a signal received from the computing device 100.

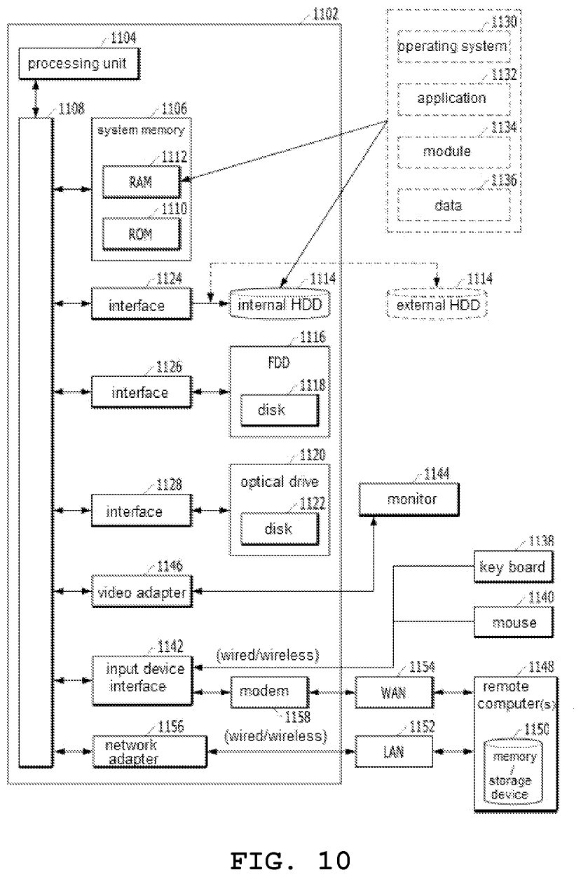

FIG. 10 is a simplified general schematic diagram for an exemplary computing environment in which aspects of the present disclosure may be implemented.

Although the present disclosure has been described above in that it can be implemented by the computing device, those skilled in the art will appreciate that the present disclosure may be implemented with computer-executable instructions that may be executed on at least one computer and/or as a combination of hardware and software and/or in combination with other program modules.

In general, program modules include routines, programs, components, data structures, etc. that may perform specific tasks or implement specific abstract data types. In addition, those skilled in the art will appreciate that the methods of the present disclosure can be implemented not only with single-processor or multiprocessor computer systems, minicomputers, and mainframe computers, but also with other computer system configurations including personal computers, handheld computing devices, microprocessor-based or programmable consumer electronics, etc. (each of which can be operated in connection with one or more associated devices).

The aspects described in the present disclosure may also be practiced in distributed computing environments where certain tasks are performed by remote processing units that are linked through a communications network. In a distributed computing environment, program modules may be located in both local and remote memory storage devices.

Computers typically include a variety of computer-readable media. Media accessible by a computer may be computer-readable media regardless of the type thereof, and the media accessible by a computer may include volatile and nonvolatile media, transitory and non-transitory media, removable and non-removable media. By way of an example, but not limited thereto, computer-readable media may include computer-readable storage media and computer-readable transmission media. Computer-readable storage media include volatile and non-volatile media, temporary and non-transitory media, removable and non-removable media implemented in any method or technology for storing information such as computer-readable instructions, data structures, program modules, or other data. Computer-readable storage media may include, but not limited thereto, RAMS, ROMs, EEPROMs, flash memory or other memory technologies, CD-ROMs, digital video disks (DVDs) or other optical disk storage devices, magnetic cassettes, magnetic tapes, magnetic disk storage devices or other magnetic storage devices, or any other media that can be accessed by a computer and used to store desired information.

Computer-readable transmission media typically implement computer-readable instructions, data structures, program modules or other data in a modulated data signal such as a carrier wave or other transport mechanism, and include any information delivery medium. The term ‘modulated data signal’ refers to a signal in which one or more of the characteristics of the signal are set or changed so as to encode information in the signal. By way of an example, but not limited thereto, computer-readable transmission media include wired media such as a wired network or direct-wired connection, and wireless media such as acoustic, RF, infrared, and other wireless media. Combinations of any of the above are also intended to be included within the scope of computer-readable transmission media.

An example environment 1100 including a computer 1102 for implementing various aspects of the disclosure is shown, and the computer 1102 includes a processing unit 1104, a system memory 1106, and a system bus 1108. The system bus 1108 connects system components including (but not limited thereto) the system memory 1106 to the processing unit 1104. The processing unit 1104 may be any of a variety of commercially available processors. A dual processor and other multiprocessor architectures may also be used as the processing unit 1104.

The system bus 1108 may be any of several types of bus structures that may further be interconnected to a memory bus, a peripheral device bus, and a local bus using any of a variety of commercial bus architectures. The system memory 1106 includes a read only memory (ROM) 1110 and a random access memory (RAM) 1112. A basic input/output system (BIOS) is stored in a non-volatile memory 1110, such as a ROM, an EPROM, an EEPROM, etc., and the BIOS may include a basic routine that helps transmission of information between components within the computer 1102, such as during startup. The RAM 1112 may also include high-speed RAM, such as static RAM for caching data.

The computer 1102 may also include an internal hard disk drive (HDD) 1114 (for example, EIDE, SATA)—this internal hard disk drive 1114 may also be configured for external use within a suitable chassis (not shown)—, a magnetic floppy disk drive (FDD) 1116 (for example, for reading from or writing to removable diskette 1118), and an optical disk drive 1120 (for example, for reading from or writing to a CD-ROM disk 1122 or for reading from or writing to other high capacity optical media such as a DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. The interface 1124 for implementing the external drive may include, for example, at least one or both of Universal Serial Bus (USB) and IEEE 1394 interface technologies.

These drives and their associated computer-readable media provide non-volatile storage of data, data structures, computer-executable instructions, and the like. In the case of the computer 1102, drives and media correspond to one that stores any data in a suitable digital format. Although the computer-readable storage media are described based on HDDs, removable magnetic disks, and removable optical media such as CDs or DVDs, those skilled in the art will be appreciated that other computer-readable storage media such as zip drives, magnetic cassettes, flash memory cards, cartridges, and the like may also be used in the exemplary operating environment, and any such media may include computer-executable instructions for performing the methods of the present disclosure.

A number of program modules including operating systems 1130, one or more application programs 1132, other program modules 1134, and program data 1136 may be stored in the drive and the RAM 1112. All or portions of the operating systems, applications, modules, and/or data may also be cached in the RAM 1112. It will be appreciated that the present disclosure may be implemented in various commercially available operating systems or combinations of operating systems.

A user may input commands and information into the computer 1102 via one or more wired/wireless input devices, for example, a pointing device such as a keyboard 1138 and a mouse 1140. Other input devices (not shown) may include a microphone, an IR remote controller, a joystick, a game pad, a stylus pen, a touch screen, and the like. Although these and other input devices are often connected to the processing unit 1104 through the input device interface 1142 that is connected to the system bus 1108, parallel ports, IEEE 1394 serial ports, game ports, USB ports, IR interfaces, and the like may be connected by other interfaces.

A monitor 1144 or other type of display devices is also coupled to the system bus 1108 via an interface such as a video adapter 1146. In addition to the monitor 1144, the computer generally includes other peripheral output devices (not shown) such as speakers, printers, and the like.

The computer 1102 may operate in a networked environment using logical connections to one or more remote computers such as remote computer(s) 1148 via wired and/or wireless communications. The remote computer(s) 1148 may refer to workstations, computing device computers, routers, personal computers, portable computers, microprocessor-based entertainment devices, peer devices, or other common network nodes, and may generally include many or all of the components described with respect to the computer 1102, but only the memory storage device 1150 is shown for simplicity. The logical connections shown in the drawings include wired/wireless connections to a local area network (LAN) 1152 and/or a larger network, for example, a wide area network (WAN) 1154. Such LAN and WAN networking environments are common in offices and companies, and facilitate enterprise-wide computer networks, such as intranets, and all of which can be connected to a worldwide computer network, for example, the Internet.

When used in the LAN networking environment, the computer 1102 is connected to the local network 1152 through a wired and/or wireless communication network interface or an adapter 1156. The adapter 1156 may facilitate the wired or wireless communication to the LAN 1152, which also includes a wireless access point installed therein for communicating with a wireless adapter 1156. When used in a WAN networking environment, the computer 1102 may include a modem 1158, may be connected to a communication computing device on the WAN 1154, or may include other devices for establishing communications over the WAN 1154. A modem 1158, which may be an internal or external and wired or wireless device, is coupled to the system bus 1108 via the serial port interface 1142. In a networked environment, program modules described with respect to the computer 1102 or portions thereof may be stored in a remote memory/storage device 1150. It will be appreciated that the network connections shown in the drawings are exemplary and other devices for establishing a communication link between the computers may be used.

The computer 1102 may communicate with any wireless devices or entities that are operated through wireless communication, such as printers, scanners, desktop and/or portable computers, portable data assistants (PDAs), communication satellites, and any devices or place, and phones in association with wireless detectable tags. It may include at least Wi-Fi and Bluetooth wireless technologies. Accordingly, the communication may be a predefined structure as in a conventional network or may simply be an ad hoc communication between at least two devices.

Wi-Fi (Wireless Fidelity) makes it possible to connect to the Internet, etc. without a wire. The Wi-Fi refers to a wireless technology such as cell phones that allow these devices, for example, computers, to transmit and receive data indoors and outdoors, that is, anywhere within the coverage area of a base station. The Wi-Fi networks use a radio technology called IEEE 802.11 (a, b, g, etc.) to provide safe, reliable, and high-speed wireless connections. The Wi-Fi can be used to connect computers to each other, to the Internet, and to wired networks (using IEEE 802.3 or Ethernet). The Wi-Fi networks may operate in unlicensed 2.4 and 5 GHz radio bands, for example, at 11 Mbps (802.11a) or 54 Mbps (802.11b) data rates, or in products that include both bands (dual band).

Those skilled in the art of the present disclosure will understand that information and signals may be represented using any of various different technologies and techniques. For example, data, instructions, commands, information, signals, bits, symbols, and chips that may be referenced from the above description may be expressed by voltages, currents, electromagnetic waves, magnetic fields or particles, optical field particles or particles, or any combination thereof.

A person having ordinary skill in the art of the present disclosure will recognize that various illustrative logical blocks, modules, processors, means, circuits and algorithm steps described in connection with the aspects disclosed herein may be implemented by electronic hardware (referred to as software for the purpose of convenience), various types of program, design codes, or a combination thereof. To clearly explain the interchangeability of hardware and software, various illustrative components, blocks, modules, circuits, and steps have been described above generally in terms of their functionality. Whether such functionality is implemented as hardware or software depends upon the specific application and design restrictions imposed on the overall system. A person skilled in the art of the present disclosure may implement the described functionality in various ways for each specific application, and such implementation decisions may not be interpreted as a departure from the scope of the present disclosure.

The various aspects presented herein may be implemented as methods, apparatuses, standard programming and/or articles of manufacture using engineering techniques. The term article of manufacture includes a computer program, a carrier, or media accessible from any computer-readable storage device. For example, the computer-readable storage medium includes magnetic storage devices (for example, hard disks, floppy disks, magnetic strips, etc.), optical disks (for example, CDs, DVDs, etc.), smart cards, and flash memory devices (for example, EEPROMs, cards, sticks, key drives, etc.), but it is not limited thereto. In addition, various storage media presented herein include one or more devices for storing information and/or other machine-readable media.

It is to be understood that the specific order or hierarchy of steps in the presented processes is an example of exemplary approaches. It is to be understood that the specific order or hierarchy of steps in the processes within the scope of the present disclosure may be rearranged based on design priorities. The appended method claims present elements of the various steps in a sample order, but are not limited to the presented specific order or hierarchy.

The description of the presented aspects is provided to enable any person skilled in the art to make or use the present disclosure. Various modifications to these aspects will be readily apparent to those skilled in the art, and the generic principles defined herein may be applied to other aspects without departing from the scope of the present disclosure. Thus, the present disclosure is not intended to be limited to the aspects presented herein, but is to be construed in the widest scope consistent with the principles and novel features presented herein.

What is claimed is:

1. A method for detecting an abnormality performed by a computing device including one or more processors, the method comprising:
acquiring first sensor data output from a first sensor among a plurality of sensors;
selecting a first neural network model determined as an optimal network model from among a plurality of neural network models different from each other;
generating first output data by inputting the first sensor data to the first neural network model; and
determining whether an abnormality exists in the first sensor data based on the first sensor data and the first output data.

2. The method of claim 1, wherein the determining of whether the abnormality exists in the first sensor data based on the first sensor data and the first output data includes:
calculating first comparison result data by comparing the first sensor data with the first output data; and
determining whether an abnormality exists in the first sensor data based on a first variable included in the first comparison result data and a first threshold corresponding to the first variable.

3. The method of claim 2, wherein the determining of whether the abnormality exists in the first sensor data based on the first variable included in the first comparison result data and the first threshold corresponding to the first variable includes
recognizing that the abnormality exists in the first sensor data and generating a first abnormality detection signal, when the first variable exceeds the first threshold, and
the first abnormality detection signal includes first information related to a cause of the abnormality recognized based on the first sensor data.

4. The method of claim 1, wherein the selecting of the first neural network model determined as an optimal network model from among the plurality of neural network models different from each other includes:
selecting a first feature value serving as a reference for determining whether an abnormality exists among feature values included in the first sensor data;
acquiring an output of each of the plurality of neural network models by individually inputting the first feature value to the plurality of neural network models; and
evaluating performances of each of the plurality of neural network models based on the acquired output, and selecting the first neural network model from among the plurality of neural network models based on scores of the evaluated performances.

5. The method of claim 4, wherein the selecting of the first feature value as the reference for determining whether the abnormality exists among the feature values included in the first sensor data includes:
selecting the first feature value using at least one of support vector machine recursive feature elimination (SVM-RFE), minimum redundancy maximum relevance (mRMR), principle component analysis (PCA), or multilinear principal component analysis (MPCA).

6. The method of claim 1, further comprising:
acquiring second sensor data output from a second sensor among the plurality of sensors;
selecting a second neural network model determined as an optimal network model from among the plurality of neural network models different from each other;
generating second output data by inputting the second sensor data to the second neural network model;
generating first combination data by combining the first output data and the second output data; and
determining whether an abnormality exists in the first combination data based on the first combination data and pre-stored normal data.

7. The method of claim 6, wherein the determining of whether the abnormality exists in the first combination data based on the first combination data and the pre-stored normal data includes:
calculating comprehensive comparison result data by comparing the first combination data with the pre-stored normal data; and
determining whether an abnormality exists in the first combination data based on a second variable included in the comprehensive comparison result data and a second threshold corresponding to the second variable.

8. The method of claim 7, wherein the determining of whether the abnormality exists in the first combination data based on the second variable included in the comprehensive comparison result data and the second threshold corresponding to the second variable includes
recognizing that the abnormality exists in the first combination data and generating a second abnormality detection signal, when the second variable exceeds the second threshold, and
the second abnormality detection signal includes second information related to a cause of the abnormality recognized based on the first combination data.

9. The method of claim 6, wherein the selecting of the second neural network model determined as an optimal network model from among the plurality of neural network models different from each other includes:
selecting a second feature value serving as a reference for determining whether an abnormality exists among feature values included in the second sensor data;
acquiring an output of each of the plurality of neural network models by individually inputting the second feature value to the plurality of neural network models; and
evaluating performances of each of the plurality of neural network models based on the acquired output, and selecting the second neural network model from among the plurality of neural network models based on scores of the evaluated performances.

10. The method of claim 9, wherein the selecting of the second feature value as the reference for determining whether the abnormality exists among the feature values included in the second sensor data includes:
selecting the second feature value using at least one of support vector machine recursive feature elimination (SVM-RFE), minimum redundancy maximum relevance (mRMR), principle component analysis (PCA), or multilinear principal component analysis (MPCA).

11. A computer program stored in a computer-readable storage medium, the computer program comprising instructions for allowing a processor of a computing device to perform the following steps in order to detect an abnormality, wherein the steps include:
acquiring first sensor data output from a first sensor among a plurality of sensors;
selecting a first neural network model determined as an optimal network model from among the plurality of neural network models different from each other;
generating first output data by inputting the first sensor data to the first neural network model; and
determining whether or not an abnormality exists in the first sensor data based on the first sensor data and the first output data.

12. A computing device for detecting an abnormality, the computing device comprising:
a processor including at least one core;
a memory configured to store a computer program that is executable by the processor; and
a network unit,
wherein the processor
acquires first sensor data output from a first sensor among a plurality of sensors,
selects a first neural network model determined as an optimal network model from among a plurality of neural network different from each other,
generates first output data by inputting the first sensor data to the first neural network, and
determines whether an abnormality exists in the first sensor data based on the first sensor data and the first output data.
